(19) United States
(12) Patent Application Publication
(10) Pub. No.: US 2014/0324583 A1
(43) Pub. Date: Oct. 30, 2014

(54) SUGGESTION BOX FOR INPUT KEYWORDS

(71) Applicants: Qiliang Chen, Beijing (CN); Weihua Tan, Beijing (CN)

(72) Inventors: Qiliang Chen, Beijing (CN); Weihua Tan, Beijing (CN)

(73) Assignee: GOOGLE INC., Mountain View, CA (US)

(21) Appl. No.: 14/347,297

(22) PCT Filed: Sep. 27, 2011
(86) PCT No.: PCT/CN2011/080241

§ 371 Date: Jul. 14, 2014

(51) Int. Cl. G06Q 30/02

(52) U.S. Cl. CPC G06Q 30/0256
USPC 705/14.54

(57) ABSTRACT

A method and a system for distributing content are provided. In the method, an input regarding an advertising keyword is received from a user. The advertising keyword is associated with one or more advertisements. Related keywords are identified from among candidate keywords based on a determined relationship of the related keywords to the advertising keyword received from the user. Reference information associated with each of the related keywords is identified. The related keywords and the reference information associated with the related keywords to the user are automatically provided. A selection of at least one of the related keywords is received from the user. The at least one selected related keywords are associated with the one or more advertisements for distribution.

### FIELD OF TECHNOLOGY

This disclosure generally relates to distributing content on the Internet, and more specifically, relates to automatically providing information related to input keywords in an advertisement online service system.

### BACKGROUND

Advertising using traditional media, such as television, radio, newspapers and magazines, is well known. Advertisers have used these types of media to reach a large audience with their advertisements (“ads”). Recently, advertising over more interactive media has become popular. For example, as the number of people using the Internet has exploded, advertisers have come to appreciate media and services offered over the Internet as a potentially powerful way to advertise. The popularity of the Internet has made it a productive advertising medium.

Some online ads service providers provide a so-called keyword tool for advertisers. By using the keyword tool, advertisers may find the keywords to be used to target their ads to potential customers.

Keywords are the words or phrases the potential customers would use when searching for the product or service. Keywords allow advertiser to target their ads to the desired audience. For example, if an advertiser sells flowers online, it can use “buy flowers” as a keyword in an online application provided by an online ads service provider. When a user enters “buy flowers” in a search engine application provided by the online ads service provider, the advertiser's ads could appear next to the search results. In addition, the advertiser's ads can appear on sites and products supported by the online ads service provider that relate to the advertiser's keyword.

By creating a highly relevant keyword list, advertisers may show their ads to only the most interested users, helping to improve the performance of their ads and maintain low cost-per-clicks (CPCs).

Keywords that are relevant and high-quality can be valuable. Overly general keywords will make it difficult to reach potential customers, and advertising will probably be less profitable. Keywords also help determine how much advertisers pay. Each of the keywords can have a CPC bid amount.

### SUMMARY

One objective of the present disclosure is to provide a suggestion box for input keywords within a single subscription page.

Another objective of the present disclosure is to provide more information on candidate keywords so that advertisers can find more proper keywords as desired.

According to the present disclosure, when an advertiser creates a new advertisements (“ads”) service or adds a new ads keyword into an existing ads service, an ads subscription system may automatically provide some suggestions on the ads keywords according to the advertiser's input. Those suggestions include some related keywords and reference information associated with each of the related keywords. Each of the related keywords may include an extension to the advertiser's input. The reference information may include a Cost-Per-Click (CPC), an estimated amount of clicks, and an estimated cost for each of the related keywords.

In some implementations, the reference information may alternatively or further include, for each of the related keywords, a trend of an amount of clicks, stored information regarding advertisement activity of the related keyword during a defined period of time, an attribute (e.g., a positive or negative connotation) of the related keyword, a meaning (including original meaning and an extension to the original meaning) of the related keyword, a version of the related keyword in a language different from the languages of the input adverting keyword, information regarding legality or usability of the related keyword in different countries and regions (e.g., due to legal, religious, and political reasons) or different service industries, an advertising usage history of the related keyword, and/or an indication of a service industry in which the related keyword was used. The reference information may be rendered to the advertiser in form of a chart, an image, audio, video, or any other media. The related keywords are provided to a web browser or a mobile device.

In some implementations, the related keywords and the reference information associated with the related keywords are automatically rendered in a new box or window close to the box or window in which the input advertising keyword is.

The implementations described herein can facilitate advertisers to subscribe to more and better ads keywords without searching for the desired keyword in a separate keyword tool in advance to obtain the reference information associated with the keywords and also facilitate the ads keyword service providers to sell more ads keywords, make more words become ads keywords, and thus increase revenue for ads.

According to one aspect of the present disclosure, a method for distributing content is provided. The method includes receiving an input regarding an advertising keyword from a user, the advertising keyword being associated with one or more advertisements; identifying related keywords from among candidate keywords based on a determined relationship of the related keywords to the advertising keyword received from the user; identifying reference information associated with each of the related keywords; automatically providing the related keywords and the reference information associated with the related keywords to the user; receiving, from the user, a selection of at least one of the related keywords; and associating the at least one selected related keywords with the one or more advertisements for distribution.

Receiving an input regarding an advertising keyword from a user may include receiving the input advertising keyword in a box or window within a web browser, and automatically providing may include: detecting whether the user has finished the input regarding the advertising keyword; and if it is determined that the input has been finished, automatically providing the related keywords and the reference information associated with the related keywords in a new box or window close to the box or window in which the input advertising keyword is.

According to another aspect of the present disclosure, a system for distributing content is provided. The system comprises: a user interface for receiving an input regarding an advertising keyword from a user, the advertising keyword being associated with one or more advertisements, transmitting the input advertising keyword to a server, automatically rendering related keywords and reference information associated with each of the related keywords received from the server to the user, receiving, from the user, a selection of at least one of the related keywords, and transmitting the at least one selected related keywords to the server; a memory coupled to the server, that stores a plurality of keywords and reference information associated with the keywords; and a server for computing an amount of searching, an amount of clicks, and a bid cost with respect to the keywords during a period of time, updating the stored reference information associated with each of the keywords based on a result of the computing, receiving, from the user interface, the input of the user, identifying, from the memory, related keywords among candidate keywords based on a determined relationship of the related keywords to the advertising keyword received from the user, identifying reference information associated with each of the related keywords, transmitting the related keywords and the reference information associated with each of the related keywords to the user interface, receiving the at least one selected related keywords from the user interface, and associating the at least one selected related keywords with the one or more advertisements for distribution.

The user interface receives the input advertising keyword in a box or window within a web browser and automatically renders related keywords and reference information associated with each of the related keywords by detecting whether the user has finished the input regarding the advertising keyword and, if it is determined that the input has been finished, automatically rendering the related keywords and the reference information associated with the related keywords in a new box or window close to the box or window in which the input advertising keyword is.

### BRIEF DESCRIPTION OF THE DRAWINGS

The various aspects, features and advantages of the disclosure will become more fully apparent to those with ordinary skill in the art, on careful consideration of the following Detailed Description and the accompanying drawings.

FIG. 1 illustrates a block diagram of a system for distributing content according to an implementation of the present disclosure.

FIG. 2 illustrates an example of a suggestion box for input ads keywords.

FIG. 3 illustrates a flow chart of a method for distributing content according to an implementation of the present disclosure.

### DETAILED DESCRIPTION

The present disclosure describes the following detailed explanation for specific implementations. Those with ordinary skill in the art would recognize that the present invention is not limited to the following specific implementations.

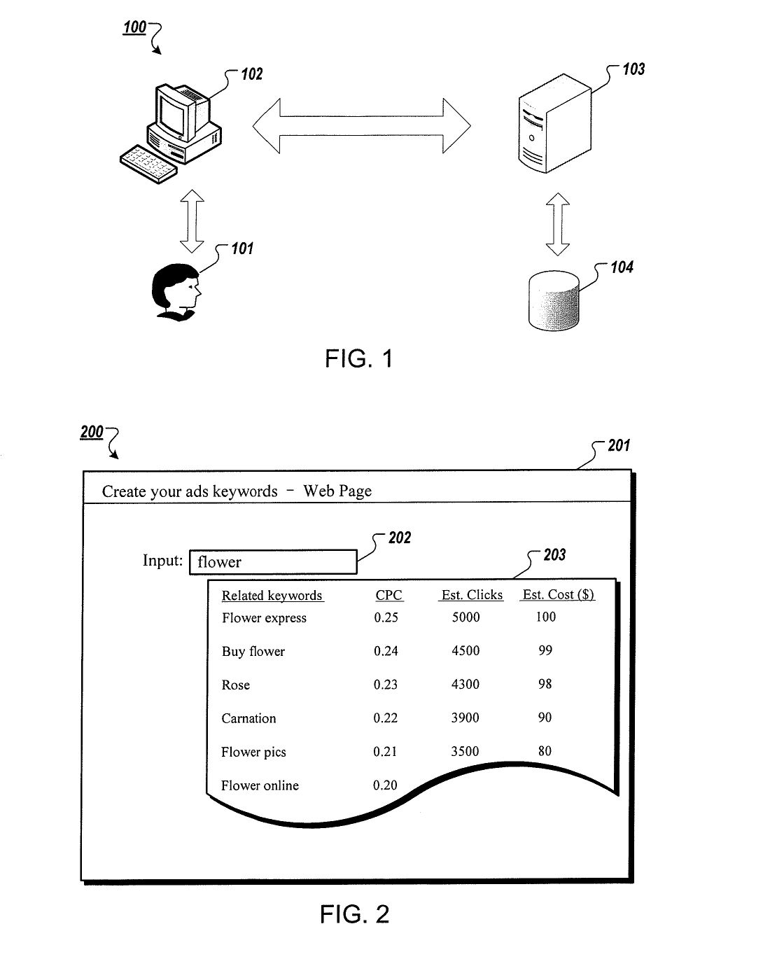

FIG. 1 illustrates a block diagram of a system 100 for distributing content according to an implementation of the present disclosure. The system 100 includes a user interface 102, a server 103, and a memory 104. The server 103 and the memory 104 are generally owned and operated by ads service providers and/or content distributors. According to an implementation of the present disclosure, the server 103 and the memory 104 maintain reference information of a plurality of keywords. For example, the server 103 computes an amount of searching, an amount of clicks, and a bid cost with respect to the keywords during a period of time, and updates the stored reference information associated with each of the keywords based on a result of the computing. The memory 104 is coupled to the server 103 and stores a plurality of keywords and reference information associated with the keywords.

The reference information mentioned above can include information associated with each of the keywords. In an implementation, the related keywords and the reference information associated with the keywords can be displayed in the user interface 102, for example, in a new box or window close to the box or window in which the keywords are displayed. Then, the user 101 may view the displayed keywords and the displayed reference information and select a desired keyword via the user interface 102 as its own ads keyword based on the reference information. Basic reference information may include Cost-Per-Clicks (CPCs), estimated clicks, and estimated cost. By considering such basic reference information, the user 101 may substantially determine an amount of clicks and a cost of ads for a candidate keyword. In some examples, the estimated ads cost can be calculated based on CPC and estimated clicks. The reference information may further include a trend of an amount of clicks, stored information regarding advertisement activity of the keyword during a defined period of time, an attribute of the keyword, and a meaning of the keyword. The reference information may further include a version of the keyword in a language different from the language of the input advertising keyword. The reference information may also include information regarding legality or usability of each of the keywords in different countries and regions or different service industries. The reference information may further include at least one of an advertising usage history of each of the keywords and an indication of a service industry in which each of the keywords was used.

FIG. 2 illustrates an example of a suggestion box for input ads keywords. In an example 200 of FIG. 2, the user interface 102 in FIG. 1 is implemented as a web page 201 on a web browser or a mobile device, as well as associated control host (not shown). Those with ordinary skill in the art would recognize that the user interface 102 may be other similar interface and associated control mechanism. As the user 101, advertisers may create or subscribe their ads keywords in the web page 201.

Specifically, the user 101 may make an input for ads keywords in a box or window 202 of the web browser. Whether the user 101 has finished the input is detected. If it is determined that the input has been finished, the related keywords and the reference information associated with the related keywords are automatically provided and rendered. The related keywords and the reference information are automatically provided and rendered in a newly generated box or window 203 at a location in the web page 201 near the input box or window 202.

As shown in FIG. 2, the user 101 inputs “flower” in the input box 202 of the web browser. Then, whether the user 101 has finished the input is detected. For example, when the user 101 only inputs “flowe”, since it is not a complete word, it is determined that the input has not been finished; however, if the user 101 has inputted one or more complete words, or the user 101 has not inputted anything for a predetermined time period such as 500 msec or 1 second, it is determined that the input has been finished. Alternatively or additionally the user could provide an input indicating that the user's input is complete (e.g., by pressing a button or pressing an enter key on an input device). In the case that the input has been finished, the related keywords and the reference information are automatically provided near the input box 202, for example in FIG. 2, in a new box or window 203 immediately below the input box 202. In the example of FIG. 2, the related keywords and the reference information are automatically provided and rendered in a form of a chart in a float box or window 203. The chart includes the related keywords column which includes “flower express”, “buy flower”, “rose”, “carnation”, “flower pics”, and “flower online”, etc. and the reference information columns which includes a CPCs column, estimated clicks column, and estimated cost column, etc. Using such a chart, the user 101 can conveniently select its own ads keywords as desired, for example by clicking in the related keywords column, on only one web page.

In the implementations described in the present disclosure, the creation or subscription and the suggestion of the keywords can be performed and completed on the same web page and thus inconvenience of using multiple web pages is mitigated. For example, the suggestion box 203 for related keywords and reference information is positioned over or “floats” on the creation or subscription web page 201 so that the user 101 may directly select its own ads keyword from the suggestion box 203, for example by simply clicking the keyword as desired, so as to perform the ads keyword creation or subscription.

Each of the related keywords includes an extension to the input advertising keyword. For example, a word can be extended to a phrase including this word. An example is an extension from “flower” to “flower pics”. Alternatively, a word can be extended to one of its subclasses or specific article. An example is an extension from “flower” to “rose” or “carnation”. In the example of FIG. 2, the reference information includes a Cost-Per-Click, an estimated amount of clicks, and an estimated advertising cost of each of the related keywords. However those with ordinary skill in the art would understand that the reference information includes, for each of the related keywords, at least one of a trend of an amount of clicks and stored information regarding advertisement activity of the related keyword during a defined period of time. For example, the trend of the amount of clicks may be displayed by means of a curve which can show a popularity degree of a keyword as time. The stored information regarding advertisement activity of the related keyword may include more aspects: for example, who and how many advertisers ordered the related keyword, who and how many users searched the related keyword, who and how many users clicked the related keyword, the actual cost for the related keyword, etc. The stored information regarding advertisement activity may be presented by means of a chart or table or list, a curve, or even a detailed report. In addition, an attribute of the related keyword and a meaning of the related keyword may be considered by the user as at least a part of the reference information. For example, although not shown in FIG. 2, if a related keyword involves a positive or negative connotation, the reference information on such an attribute can be provided to the user for selection. In another example, if a related keyword has an original meaning and an extension to the original meaning, the reference information on such different meanings should be provided to the user for selection. For example, the original meaning of “flower” is such a structure having showy or colorful parts or a blossom. The extensions to the meaning of “flower” may include: (i) something, such as a metaphor or a figure of speech, that resembles a flower in shape, fineness, or attractiveness; (ii) a period of highest development or the peak (e.g., “business is flowering”); and (iii) the highest example or best representative (e.g., “this building is the architectural flower of the city”). In the above example, an advertiser not in a business related to a “flower” may see an opportunity in selecting this keyword based on its extension meaning(s) for its online ads. In addition, different language versions of the related keywords may be provided to the user as the reference information. For example, the information to indicate that “flower” in Chinese language is “ [symbol] ” or “ [symbol] ” may be provided to the user for reference. The reference information may include information regarding legality or usability of each of the related keywords in different countries and regions or different service industries. For example, although not shown in FIG. 2, if a related keyword involves forbidden or limited usage in different countries or regions or different service industries due to legal, religious, erotic, or political reasons, the reference information for notifying such situations may be useful to the user for selection and thus should be provided. The reference information may further include an advertising usage history of each of the related keywords and an indication of a service industry in which each of the related keywords was used. For example, the related keyword “flower online” may be of e-business industry, “flower plant” may be of agriculture industry, and “flower party” may be of entertainment industry, and so on. By reviewing an advertising usage history of each of the related keywords, the user may even grip ads activities and strategy of the competitors. The implementations described in the present disclosure allow the user to obtain more helpful and more valuable suggestions on the ads keywords by providing more reference information.

In the example of FIG. 2, the user interface 102 automatically provides, or specifically displays, the related keywords and the reference information in a form of chart. However, those with ordinary skill in the art would recognize that the automatically providing of the related keywords and the reference information can also be performed in a form of an image, audio, video, or any other similar media. For example, in order to provide legality information on the related keywords in different countries or regions or different language versions of the related keywords, a map may be displayed; in order to provide an advertising usage history of the related keywords or other reference information, some audio or video clips or materials may be given.

The user may select the related keyword as desired by clicking the related keywords, as its own final ads keyword for distribution, based on the related keywords and the reference information which are automatically provided or rendered. Specifically, the user 101 may select the related keyword in the user interface 102 by, for example, clicking the desired keyword, among the related keywords all displayed in the user interface 102, after reviewing the displayed reference information associated with each related keyword.

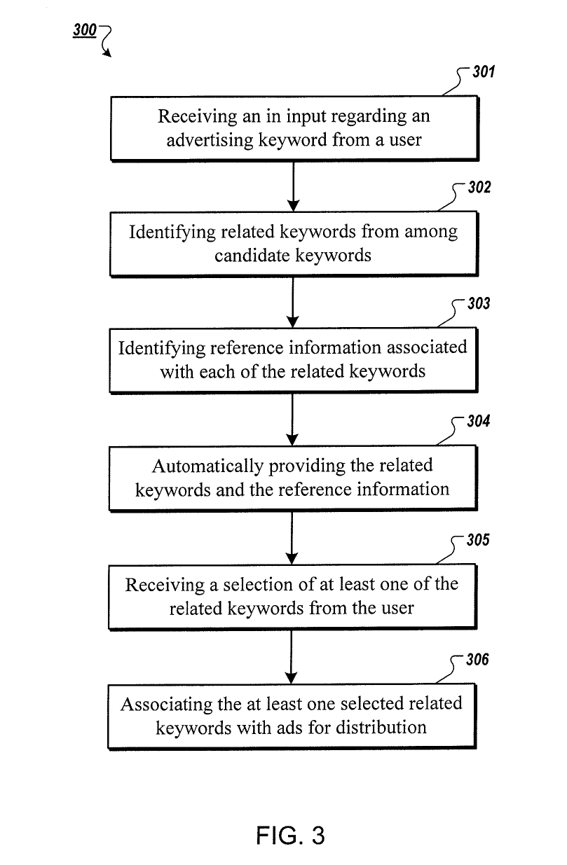

FIG. 3 illustrates a flow chart 300 of a method for distributing content according to an implementation of the present disclosure.

The flow chart 300 begins with operation 301 in which an input regarding an advertising keyword is received from a user. The advertising keyword is associated with one or more advertisements. In the example of FIG. 2, the user 101 inputs “flower” via the user interface 102. The input is transmitted to the server 103 of FIG. 1 by the interface 102.

In operation 302, related keywords are identified from among candidate keywords based on a determined relationship of the related keywords to the advertising keyword received from the user. The server 103 side will perform an analysis for the input advertising keyword. If the input is an incomplete word, the server 103 identifies the complete word according to the input incomplete word. If the input is one or more complete words, the server 103 identifies those words or the extension of those words from the memory 104. As explained in the foregoing paragraphs, a word can be extended to a phrase including this word or be extended to one of its subclasses or specific article. The server 103 has an intelligence to identify the above-mentioned related keywords according to the input from the user. In the example where the input is “flower”, after receipt of the input, the server 103 identifies related keywords such as “flower express”, “buy flower”, “rose”, “carnation”, “flower pics”, and “flower online”, etc. from among candidate keywords stored in the memory 104, according to the extension of “flower”.

In operation 303, reference information associated with each of the related keywords is identified. After the related keywords are determined, the server 103 may further determine the reference information associated with each of the determined related keywords from the memory 104. As mentioned above, the reference information is maintained by the server 103 and the memory 104 and stored in the memory 104. When the related keywords are determined, the server 103 retrieves the reference information associated with the related keywords from the memory 104. For example, if one of the related keyword is “rose”, the server 103 can search any information associated with “rose” stored in the memory 104, such as CPC of “rose”, clicks of “rose”, cost of “rose” and any other information stored in the memory 104. The skilled in the art would understand that such reference information is continuously updated based on usage of the keywords. Continuing with the example of the word “rose”, the server 103 computes an amount of searching “rose”, an amount of clicking “rose”, and a bid cost with respect to “rose” during a period of time, and updates the stored information associated with “rose” based on a result of the computing.

In operation 304, the related keywords and the reference information are automatically provided to the user 101. The server 103 transmits the identified related keywords and the accordingly identified reference information to the user interface 102. The user interface 102 automatically renders the related keywords and the reference information to the user 101. As described above, such automatically rendering includes rendering the reference information in a form of chart, image, audio, video, or other similar media. An example of the chart has been give in FIG. 2. As shown in the box or window 203 of FIG. 2, the related keywords such as “flower express” and “buy flower” and the reference information such as CPC, estimated clicks and estimated cost are listed in the form of a chart. Some reference information may be rendered in other forms. For example, different languages or regions may be shown as different maps or flag images; some data may be processed as curves to be shown; and some information can be well understood by viewing some background audio and/or video.

The automatically providing of the reference information includes automatically transmitting the related keywords and the reference information to a web browser or a mobile device. The receiving of operation 301 may be implemented as receiving the input advertising keyword in a box or window 202 within a web page 201. Whether the user 101 has finished the input in the box or window 202 is detected. If it is determined that the input has been finished, the related keywords and the reference information associated with the related keywords are automatically provided, as shown in operation 304, in a new suggestion box or window 203 close to the input box or window 202. In addition, the automatically providing of the related keywords and the reference information may include automatically providing the related keywords and the reference information in real time as the user types the advertising keyword.

In operation 305, a selection of at least one of the related keywords is received from the user 101. Operation 305 may be performed by the user interface 102. If the user 101 has made a selection of at least one of the related keywords, for example, by clicking at least one of the related keywords in the new suggestion box or window 203, it implies that the user 101 has chosen the at least one of the related keywords as its ads keyword(s) for distribution. The user interface 102 transmits the selected related keyword(s) to the server 103, or notifies the server 103 of the selection in any other manner.

After receipt of acknowledgement or confirmation, or as a default case, in operation 306, the at least one selected related keywords is associated with the one or more advertisements for distribution. The specific distribution will not be described in this document, in order to avoid unnecessarily obscuring the scope and the spirit of the present disclosure.

Regarding the detailed explanation for the related keywords and the reference information mentioned in the flow chart 300 of FIG. 3, please refer to the above description and explanation related to FIG. 2.

Advertisers generally may pursue useful suggestions or reference information for related keywords when they create or subscribe their own ads keywords, so that they could easily select proper keywords as desired, for example by simply clicking the related keywords. Advertisers may create or subscribe more and better ads keywords by reference to the suggestion and the reference information according to an implementation of the present disclosure, so as to advertise their products or services in a scope as broad and precise as possible. From the viewpoint of online ads keyword service providers, they may sell more keywords, or make more keywords trigger advertisements, and as a result, they can expect an increase in the revenue on ads.

Implementations of the subject matter and the functional operations described in this specification may be implemented in digital electronic circuitry, in tangibly-embodied computer software or firmware, in hardware, including the structures disclosed in this specification and their structural equivalents, or in combinations of one or more of them. Implementations of the subject matter described in this specification may be implemented as one or more computer programs, i.e., one or more modules of computer program instructions encoded on a computer storage medium for execution by, or to control the operation of, data processing apparatus. Alternatively or in addition, the program instructions may be encoded on a propagated signal that is an artificially generated signal, e.g., a machine-generated electrical, optical, or electromagnetic signal, that is generated to encode information for transmission to suitable receiver apparatus for execution by a data processing apparatus. The computer storage medium may be a machine-readable storage device, a machine-readable storage substrate, a random or serial access memory device, or a combination of one or more of them.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application-specific integrated circuit).

To provide for interaction with a user, implementations of the subject matter described in this specification may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Particular embodiments of the subject matter have been described. Other embodiments are within the scope of the following claims. For example, the actions recited in the claims may be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, at one or more processors, an input regarding an advertising keyword from a user, the advertising keyword being associated with one or more advertisements;
identifying, by the one or more processors, related keywords from among candidate keywords based on a determined relationship between the related keywords to the advertising keyword received from the user;
identifying, by the one or more processors, reference information associated with at least some of the related keywords; and
automatically providing, by the one or more processors, at least some of the related keywords and the reference information associated with the at least some of the related keywords to the user.

2. The method of claim 1, further comprising receiving, from the user, a selection of at least one of the related keywords.

3. The method of claim 1, further comprising associating the at least one selected related keywords with the one or more advertisements for distribution.

4. The method of claim 1, wherein at least some of the related keywords includes an extension of the input advertising keyword.

5. The method of claim 1, wherein the reference information includes at least one of a Cost-Per-Click, an estimated amount of clicks, and an estimated advertising cost of each of the related keywords.

6. The method of claim 1, wherein the reference information includes, for each of the related keywords, at least one of information related to a trend in an amount of clicks, stored information regarding advertisement activity of the related keyword during a defined period of time, an attribute of the related keyword, and a meaning of the related keyword.

7. The method of claim 1, wherein the reference information includes a version of the related keyword in a language different from the language of the input advertising keyword.

8. The method of claim 1, wherein the reference information includes information regarding legality or usability of at least some of the related keywords.

9. The method of claim 1, wherein the reference information includes at least one of an advertising usage history of at least some of the related keywords and an indication of a service industry in which each of the related keywords was used.

10. The method of claim 1, wherein the reference information is automatically provided to the user in form of a chart, an image, audio, or video.

11. The method of claim 1, wherein automatically providing comprises automatically transmitting the related keywords and the reference information to a web browser or a mobile device.

12. The method of claim 1, wherein receiving an input regarding an advertising keyword from a user includes receiving the input advertising keyword in a box or window displayed within a web browser; and
wherein automatically providing includes:
detecting whether the user has finished the input regarding the advertising keyword; and
if it is determined that the input has been finished, automatically providing the related keywords and the reference information associated with the related keywords in a new box or window close to the box or window in which the input advertising keyword is displayed.

13. The method of claim 1, wherein automatically providing includes automatically providing the related keywords and the reference information in real time as the user inputs the advertising keyword.

14. A system comprising:
a memory storing a plurality of keywords and reference information associated with the keywords; and
a server coupled to the memory and configured for
computing an amount of searching, an amount of clicks, and a bid cost with respect to advertising keywords during a period of time, the advertising keywords each associated with one or more advertisements,
updating the stored reference information associated with each of the keywords based on a result of the computing,
receiving, from a user interface, input of a user, the input comprising an advertising keyword associated with one or more advertisements,
identifying, from the memory, related keywords among candidate keywords based on a determined relationship of the related keywords to the advertising keyword received from the user interface,
identifying reference information associated with each of the related keywords,
transmitting the related keywords and the reference information associated with each of the related keywords to the user interface for automatic rendering on the user interface.

15. The system of claim 14, wherein the server receives the at least one selected related keywords from the user interface.

16. The system of claim 14, wherein the server associates the at least one selected related keywords with the one or more advertisements for distribution.

17. The system of claim 14, wherein each of the related keywords includes an extension to the input advertising keyword.

18. The system of claim 14, wherein the reference information includes a Cost-Per-Click, an estimated amount of clicks, and an estimated advertising cost of each of the related keywords.

19. The system of claim 14, wherein the reference information includes, for each of the related keywords, at least one of a trend of an amount of clicks, stored information regarding advertisement activity of the related keyword during a defined period of time, an attribute of the related keyword, and a meaning of the related keyword.

20. The system of claim 14, wherein the reference information includes a version of the related keyword in a language different from the language of the input advertising keywords.

21. The system of claim 14, wherein the reference information includes information regarding legality or usability of each of the related keywords in different countries and regions or different service industries.

22. The system of claim 14, wherein the reference information includes at least one of an advertising usage history of each of the related keywords and an indication of a service industry in which each of the related keywords was used.

23. A system comprising:
a user interface configured for
receiving an input regarding an advertising keyword from a user, the advertising keyword being associated with one or more advertisements,
transmitting the input advertising keyword to a server, and
automatically rendering related keywords and reference information associated with each of the related keywords received from the server, the related keywords being identified from among candidate keywords based on a determined relationship between the related keywords to the advertising keyword received from the user, and the reference information being associated with at least some of the related keywords.

24. The system of claim 23, wherein the user interface receives, from the user, a selection of at least one of the related keywords.

25. The system of claim 23, wherein the user interface transmits the at least one selected related keywords to the server.

26. The system of claim 23, wherein the user interface automatically renders the reference information in form of a chart, an image, audio, or video.

27. The system of claim 23, wherein the user interface is implemented on a web browser or a mobile device.

28. The system of claim 23, wherein the user interface includes a web page.

29. The system of claim 23, wherein the user interface receives the input advertising keyword in a box or window displayed within a web browser; and
wherein the user interface automatically renders related keywords and reference information associated with each of the related keywords by
detecting whether the user has finished the input regarding the advertising keyword; and
if it is determined that the input has been finished, automatically rendering the related keywords and the reference information associated with the related keywords in a new box or window close to the box or window in which the input advertising keyword is displayed.

30. The system of claim 23, wherein the user interface automatically renders related keywords and reference information associated with each of the related keywords by automatically rendering the related keywords and the reference information in real time as the user inputs the advertising keyword.

31. Computer readable media storing software comprising instructions executable by a processing device and upon such execution cause the processing device to perform operations comprising:
receiving an input regarding an advertising keyword from a user, the advertising keyword being associated with one or more advertisements;
identifying related keywords from among candidate keywords based on a determined relationship between the related keywords to the advertising keyword received from the user;
identifying reference information associated with at least some of the related keywords; and
automatically providing at least some of the related keywords and the reference information associated with the at least some of the related keywords to the user.

32-43. (canceled)
